(19) United States
(12) Patent Application Publication
(10) Pub. No.: US 2019/0073546 A1
(43) Pub. Date: Mar. 7, 2019

(54) DRIVER STATE RECOGNITION APPARATUS, DRIVER STATE RECOGNITION SYSTEM, AND DRIVER STATE RECOGNITION METHOD

(71) Applicant: OMRON Corporation, Kyoto-shi (JP)

(72) Inventors: Hatsumi AOI, Kyotanabe-shi (JP); Tomoyoshi AIZAWA, Kyoto-shi (JP); Tadashi HYUGA, Hirakata-shi (JP); Kazuyoshi OKAJI, Omihachiman-shi (JP); Koji TAKIZAWA, Kyoto-shi (JP); Hiroshi SUGAHARA, Kyoto-shi (JP)

(73) Assignee: OMRON Corporation, Kyoto-shi (JP)

(21) Appl. No.: 16/030,975

(22) Filed: Jul. 10, 2018

(30) Foreign Application Priority Data
Sep. 5, 2017 (JP) 2017-169962

(51) Int. Cl. G06K 9/00; H04N 7/18

(52) U.S. Cl. CPC G06K 9/00845; H04N 7/18; G06K 9/00375

(57) ABSTRACT

A driver state recognition apparatus that recognizes a state of a driver of a vehicle provided with an autonomous driving system includes an image acquisition unit that acquires an image captured by a camera that captures the driver, a hand detection unit that detects the hands of the driver from the image acquired by the image acquisition unit, an object holding state detection unit that detects the holding state of an object by the hands of the driver detected by the hand detection unit, and a readiness determination unit that determines whether the driver is in a state of being able to immediately operate a steering wheel of the vehicle during autonomous driving, based on the holding state of the object detected by the object holding state detection unit.

### CROSS-REFERENCES TO RELATED APPLICATIONS

This application claims priority to Japanese Patent Application No. 2017-169962 filed Sep. 5, 2017, the entire contents of which are incorporated herein by reference.

### FIELD

The disclosure relates to a driver state recognition apparatus, a driver state recognition system, and a driver state recognition method, and more particularly to a driver state recognition apparatus, a driver state recognition system, and a driver state recognition method that recognize a state of a driver of a vehicle that can drive autonomously.

### BACKGROUND

In recent years, development of autonomous driving technologies for vehicles has been actively pursued. International investigations on technical standards related to autonomous driving vehicles have also been pursued. For example, regarding the international standards related to autonomous steering wheel operation, discussions are currently ongoing for revising the international standards relating to autonomous steering wheel operation technologies (such as autonomous lane keeping technologies and autonomous lane changing technologies) for a state in which the steering wheel is held when the vehicle is traveling at or over 10 km per hour.

In addition, there are plans to also pursue investigations regarding the international standards relating to autonomous steering wheel operation technologies (such as autonomous lane keeping technologies and continuous autonomous driving technologies) for a state in which the steering wheel is not held when a vehicle is traveling at or over 10 km per hour. For establishing standards related to the above autonomous steering wheel operation technologies for a state in which the steering wheel is not held, various requirements are considered to be needed. As one of these requirements, for example, monitoring the state of the driver in an autonomous driving system so as to enable the driver to take over manual driving from autonomous driving smoothly when a request is received from the system is being investigated.

As one technology for monitoring the state of the driver, the following JP 2014-106573 discloses a technology for determining, while the driver is driving a vehicle, whether the driver is operating a portable terminal based on steering wheel holding information and information on the line of sight direction of the driver, and, if it is determined that the driver is operating a portable terminal, restricting the functions of the portable terminal. According to the technology disclosed in JP 2014-106573, it is possible to avoid hindering safe driving by restricting operation functions of a portable terminal while the driver is driving a vehicle.

Incidentally, if, in a situation in which the driver is operating a portable terminal during autonomous driving, an abnormality or a failure occurs in the autonomous driving system and a takeover request for taking over manual driving is suddenly issued, it is not easy for the driver to immediately take over a driving operation.

Accordingly, it is also conceivable to adopt the technology disclosed in JP 2014-106573 as a technology for recognizing a state of a driver of a vehicle that can drive autonomously. However, in the technology disclosed in JP 2014-106573, it is determined that a driver is operating a portable terminal in a case where the driver is not holding the steering wheel with both hands and the line of sight of the driver is not facing forward. That is, in the technology disclosed in JP 2014-106573, an actual state of the hands of the driver in the case where the driver is not holding the steering wheel cannot be recognized at all.

During autonomous driving that does not require holding the steering wheel, it is envisioned that the driver will carry out actions while holding various items in his or her hands, apart from holding and operating a portable terminal. These actions also include actions that make it difficult to immediately take over a driving operation, such as eating or drinking with both hands. In the technology disclosed in JP 2014-106573, various actions by the driver using his or her hands that are envisioned to be carried out during autonomous driving cannot be appropriately recognized, and thus there is a problem in that it cannot be accurately recognized whether the hands of the driver are in a state of being able to immediately take over operation of the steering wheel.

JP 2014-106573 is an example of background art.

### SUMMARY

One or more aspects have been made in view of the above circumstances, and one or more aspects may provide a driver state recognition apparatus, a driver state recognition system, and a driver state recognition method that can accurately recognize whether a state of the hands of a driver during autonomous driving is a state of being able to immediately take over operation of a steering wheel.

In order to achieve the above object, a driver state recognition apparatus according to one or more aspects is a driver state recognition apparatus for recognizing a state of a driver of a vehicle provided with an autonomous driving system, the apparatus including:

an image acquisition unit configured to acquire an image captured by a camera configured to capture the driver;

a hand detection unit configured to detect a hand of the driver from the image acquired by the image acquisition unit;

an object holding state detection unit configured to detect a holding state of an object by the hand of the driver that is detected by the hand detection unit;

a readiness determination unit configured to determine whether the hand of the driver is in a state of being able to immediately operate a steering wheel of the vehicle during autonomous driving, based on the holding state of the object that is detected by the object holding state detection unit, and the object being an object that is different from an accessory of the vehicle that the driver operates with the hand.

According to the above driver state recognition apparatus, hands of the driver are detected from the image, the holding state of the object by the hands of the driver is detected, and it is determined whether the hands of the driver are in a state of being able to immediately operate the steering wheel of the vehicle during autonomous driving, based on the holding state of the object. In this manner, it is possible to accurately recognize whether the hands of the driver are in a state of being able to immediately take over the operation of the steering wheel during autonomous driving, and it is possible to appropriately provide support such that takeover of manual driving from autonomous driving, particularly takeover of the operation of the steering wheel, can be performed promptly and smoothly, even in cases such as where a failure occurs in the autonomous driving system during autonomous driving.

Also, in the driver state recognition apparatus according to one or more aspects, the object holding state detection unit may detect a feature of a region portion that moves with the hand of the driver from the image, and may determine whether the driver is in a state of holding the object, based on the feature of the region portion that moves with the hand of the driver and is detected from the image.

According to the above driver state recognition apparatus, the feature of the region portion that moves with the hands of the driver is detected from the image, and it is detected whether the driver is in a state of holding the object, based on the feature of the region portion, detected from the image, that moves with the hands of the driver. If the object is held by the hands of the driver, the object moves with the hands of the driver, and thus, by analyzing the feature of the region portion that moves with the hands of the driver in the image, that is, by analyzing the feature of a region portion adjacent to the hands of the driver, it is possible to accurately detect whether the driver is in a state of holding the object. The feature of the region portion that moves with the hands of the driver may be the size or shape of the region portion, may be color information or luminance information, or may be a combination thereof.

Also, in the driver state recognition apparatus according to one or more aspects, if the object holding state detection unit detects a predetermined state in which the driver is not holding the object in either hand, the readiness determination unit may determine that the driver is in the state of being able to immediately operate the steering wheel during autonomous driving.

According to the above driver state recognition apparatus, if the predetermined state in which the driver is not holding the object in either hand is detected, it is determined that the driver is in a state of being able to immediately operate the steering wheel during autonomous driving. The predetermined state in which the driver is not holding the object in either hand may be a state in which, for example, a state where the driver is not holding the object in either hand has continued for a predetermined time period, or may be a state in which a state where the driver is not holding the object in either hand has been detected a predetermined number of times within a certain time period. In this manner, it is possible to accurately determine that the driver is in a state of being able to immediately operate the steering wheel with both hands.

Also, in the driver state recognition apparatus according to one or more aspects, if the object holding state detection unit detects a predetermined state in which the driver is holding the object with at least one hand, the readiness determination unit may determine that the driver is not in the state of being able to immediately operate the steering wheel during autonomous driving.

According to the above driver state recognition apparatus, if the predetermined state in which the driver is holding the object with at least one hand is detected, it is determined that the driver is not in a state of being able to immediately operate the steering wheel during autonomous driving. The predetermined state in which the driver is holding the object with at least one hand may be a state in which, for example, a state where the driver holds the object with at least one hand has continued for a predetermined time period, or may be a state in which a state where the driver holds the object with at least one hand has been detected a predetermined number of times within a certain time period. In this manner, it is possible to accurately determine that the driver is not in a state of being able to immediately operate the steering wheel with both hands.

Also, in the driver state recognition apparatus according to one or more aspects, if the object holding state detection unit detects the holding state of the object, the readiness determination unit may determine whether the hand of the driver is in the state of being able to immediately operate the steering wheel of the vehicle during autonomous driving, based on a size of the object.

According to the above driver state recognition apparatus, it is determined whether the hands of the driver are in a state of being able to immediately operate the steering wheel of the vehicle during autonomous driving based on the size of the object, and thus, for example, if the size of the object is a size that does not hinder holding the steering wheel, it is possible to determine that there is readiness.

Also, the driver state recognition apparatus according to one or more aspects may include a steering wheel holding state detection unit configured to detect a holding state of the steering wheel by the driver, and the readiness determination unit may determine whether the driver is in the state of being able to immediately operate the steering wheel during autonomous driving, based on the holding state of the object that is detected by the object holding state detection unit and the holding state of the steering wheel that is detected by the steering wheel holding state detection unit.

According to the above driver state recognition apparatus, it is determined whether the driver is in a state of being able to immediately operate the steering wheel during autonomous driving, based on the holding state of the object and the holding state of the steering wheel. In this manner, it is possible to prevent erroneously detecting that the state of holding the steering wheel is a state of holding an object other than the steering wheel, and it is possible to accurately detect whether the driver is holding an object other than the steering wheel. As a result, it is possible to improve determination accuracy for determining whether the hands of the driver are in a state of being able to immediately operate the steering wheel of the vehicle during autonomous driving.

Also, the driver state recognition apparatus according to one or more aspects may include a sensor signal acquisition unit configured to acquire a sensor signal that is based on contact of the hand of the driver from a sensor provided in the steering wheel, and the steering wheel holding state detection unit may detect the holding state of the steering wheel by the driver, based on the sensor signal that is acquired by the sensor signal acquisition unit.

According to the above driver state recognition apparatus, a holding state of the steering wheel by the driver is detected, based on the sensor signal acquired from the sensor provided in the steering wheel. Accordingly, by acquiring the sensor signal from the sensor provided in the steering wheel, it is possible to directly detect a holding state of the steering wheel by the driver.

Also, in the driver state recognition apparatus according to one or more aspects, the steering wheel holding state detection unit may detect the holding state of the steering wheel by the driver from the image.

According to the above driver state recognition apparatus, a holding state of the steering wheel by the driver can be detected from the image, without providing a sensor in the steering wheel or the like. For example, in a case where the motion of the hands of the driver that is detected from the image is the same as the direction in which the steering wheel is rotated, it may be determined that the driver is holding the steering wheel. Also, in a case where the motion of the hands of the driver that is detected from the image is different from the direction in which the steering wheel is rotated, it may be determined that the driver is not holding the steering wheel. Also, by detecting whether the hands of the driver are on the steering wheel from the image, a holding state of the steering wheel by the driver may be detected. In addition, a holding state of the steering wheel may be detected from a method in which the arms of the driver are extended or the like.

Also, the driver state recognition apparatus according to one or more aspects may include a support execution unit configured to execute support for the driver, if the readiness determination unit determines that the hand of the driver is not in the state of being able to immediately operate the steering wheel.

According to the above driver state recognition apparatus, if it is determined that the hands of the driver are not in the state of being able to immediately operate the steering wheel, support for the driver is executed. In this manner, it is possible to execute support for prompting the driver to correct the state of his or her hands so as to keep a state of the hands that enables the driver to immediately operate the steering wheel even during autonomous driving.

Also, the driver state recognition apparatus according to one or more aspects may include an information acquisition unit configured to acquire information arising during autonomous driving from the autonomous driving system, and the support execution unit may execute notification processing to the driver, based on a determination result from the readiness determination unit and the information arising during autonomous driving that is acquired by the information acquisition unit.

According to the above driver state recognition apparatus, notification processing is performed according to the determination result from the readiness determination unit and the information arising during autonomous driving that is acquired by the information acquisition unit. In this manner, it is not required to needlessly perform various notifications to the driver according to the situation of the autonomous driving system, thus enabling power and processing required for notification to be reduced.

Also, in the driver state recognition apparatus according to one or more aspects, the information arising during autonomous driving may include information for determining whether surroundings of the vehicle are in a safe state, and if it is determined by the readiness determination unit that the hand of the driver is not in the state of being able to immediately operate the steering wheel, the support execution unit may execute notification processing after changing a notification level for prompting the driver to correct a state of the hand, according to whether the surroundings of the vehicle are in a safe state.

According to the above driver state recognition apparatus, if it is determined that the hands of the driver are not in the state of being able to immediately operate the steering wheel, it is possible to perform notification processing after changing the notification level for prompting the driver to correct the state of his or her hands, according to whether the surroundings of the vehicle are in a safe state. As the information for determining whether the surroundings of the vehicle are in a safe state, it may be preferable that, for example, monitoring information of the surroundings of the vehicle is included. The monitoring information of the surroundings of the vehicle may be, for example, information indicating that the vehicle is being rapidly approached by another vehicle, or may be information indicating that the vehicle will travel a road where the functional limit of the system is envisioned, such as a narrow road with sharp curbs.

In a case where the surroundings of the vehicle are not in a safe state, for example, it may be preferable to raise the notification level and more strongly alert the driver, such as by combining display, audio, vibration, and so on, for example, so that the driver adopts a state of the hands in which the driver can immediately take over the operation of the steering wheel. On the other hand, if the surroundings of the vehicle are in a safe state, it may be preferable to lower the notification level and perform a low-level notification by display only, for example.

Also, in the driver state recognition apparatus according to one or more aspects, the information arising during autonomous driving may include takeover request information for taking over manual driving from autonomous driving, and if it is determined by the readiness determination unit that the hand of the driver is not in the state of being able to immediately operate the steering wheel, and the information acquisition unit acquires the takeover request information, the support execution unit may execute notification processing for prompting the driver to take over the operation of the steering wheel.

According to the above driver state recognition apparatus, if it is determined that the hands of the driver are not in a state of being able to immediately operate the steering wheel, and the takeover request information is acquired, it is possible to perform the notification processing for prompting the driver to take over the operation of the steering wheel. The takeover request information may be, for example, information indicating that the vehicle has entered takeover zone for taking over manual driving from autonomous driving, or information notifying that an abnormality or a failure has occurred in a part of the autonomous driving system. If the takeover request information is acquired, actual operation of the steering wheel is required, and thus, for example, it may be preferable that notification is performed such that the driver takes hold the steering wheel swiftly.

Also, a driver state recognition system according to one or more aspects may include any of the above driver state recognition apparatuses, and a camera configured to capture the driver.

According to the above driver state recognition system, the system is constituted to include the driver state recognition apparatus and a camera that captures the driver. In this configuration, it is possible to construct a system that can accurately recognize whether the hands of the driver are in a state of being able to immediately take over the steering wheel even during the autonomous driving, and that is also able to appropriately provide support such that takeover of manual driving from autonomous driving can be performed promptly and smoothly, even in cases such as where a failure occurs in the autonomous driving system during autonomous driving.

Also, a driver state recognition method according to one or more aspects is a driver state recognition method for recognizing a driver state of a vehicle provided with an autonomous driving system, the method including:

a step of acquiring an image captured by a camera configured to capture the driver;

a step of storing the acquired image in an image storage unit;

a step of reading out the image from the image storage unit;

a step of detecting a hand of the driver from the read image;

a step of detecting a holding state of an object by the detected hand of the driver; and

a step of determining whether the hand of the driver is in a state of being able to immediately operate the steering wheel of the vehicle during autonomous driving, based on the detected holding state of the object, and the object being an object that is different from an accessory of the vehicle that the driver operates with the hand.

According to the above driver state recognition method, the hands of the driver are detected from the image, the holding state of the object by the hands of the driver is detected, it is determined whether the hands of the driver are in a state of being able to immediately operate the steering wheel of the vehicle during autonomous driving, based on the holding state of the object. In this manner, it is possible to accurately recognize whether the hands of the driver are in a state of being able to immediately take over the operation of the steering wheel during autonomous driving, and it is also possible to appropriately provide support such that takeover of manual driving from autonomous driving, particularly takeover of the operation of the steering wheel, can be performed promptly and smoothly, even in cases such as where a failure occurs in the autonomous driving system during autonomous driving.

### BRIEF DESCRIPTION OF THE DRAWINGS

FIG. 1 is a block diagram illustrating a configuration of a relevant section of an autonomous driving system that includes a driver state recognition apparatus according to an embodiment 1.

FIG. 2 is a side view illustrating a vicinity of a driver's seat of a vehicle in which a driver state recognition system according to an embodiment 1 is installed.

FIG. 3 is a block diagram illustrating a hardware configuration of a driver state recognition apparatus according to an embodiment 1.

FIG. 4 is a flowchart illustrating a processing operation performed by a control unit in a driver state recognition apparatus according to an embodiment 1.

FIG. 5 is a block diagram illustrating a configuration of a relevant section of an autonomous driving system that includes a driver state recognition apparatus according to an embodiment 2.

FIG. 6 is a side view illustrating a vicinity of a driver's seat of a vehicle in which a driver state recognition system according to an embodiment 2 is installed.

FIG. 7 is a block diagram illustrating a hardware configuration of a driver state recognition apparatus according to an embodiment 2.

FIG. 8 is a flowchart illustrating a processing operation performed by a control unit in a driver state recognition apparatus according to an embodiment 2.

### DETAILED DESCRIPTION

Hereinafter, embodiments of a driver state recognition apparatus, a driver state recognition system, and a driver state recognition method will be described based on the drawings. Note that the following embodiments are specific examples of the present invention and various technical limitations are applied, but the scope of the present invention is not limited to these embodiments unless particularly stated in the following description.

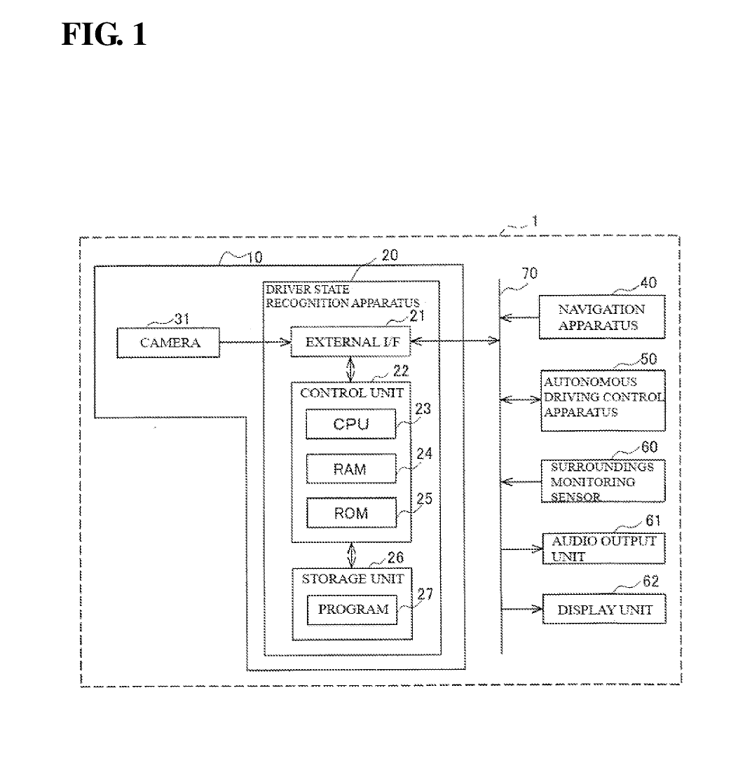

FIG. 1 is a block diagram showing a configuration of a relevant section of an autonomous driving system 1 that includes a driver state recognition apparatus 20 according to an embodiment 1.

The autonomous driving system 1 is configured to include the driver state recognition apparatus 20, a camera 31, a navigation apparatus 40, an autonomous driving control apparatus 50, a surroundings monitoring sensor 60, an audio output unit 61, and a display unit 62, and these units are connected via a bus line 70.

The autonomous driving system 1 includes an autonomous driving mode in which the system, as the agent, autonomously performs at least a part of travel control including acceleration, steering, and braking of a vehicle and a manual driving mode in which a driver performs the driving operation, and the system is constituted such that these modes can be switched.

The autonomous driving mode in an embodiment is envisioned as being a mode in which the autonomous driving system 1 autonomously performs all of acceleration, steering, and braking and the driver copes with requests when received from the autonomous driving system 1 (automation level equivalent to so-called level 3 or greater), but application of an embodiment is not limited to this automation level. Also, times at which the autonomous driving system 1 requests takeover of manual driving during autonomous driving include, for example, at a time of the occurrence of a system abnormality or failure, at a time of the functional limit of the system, and at a time of the end of an autonomous driving interval.

The driver state recognition apparatus 20 is an apparatus for recognizing a state of a driver of a vehicle including the autonomous driving system 1, and is an apparatus for providing support, by recognizing a state of the hands of the driver and determining whether the driver is in a state of being able to immediately operate a steering wheel even during autonomous driving, so as to enable the driver to immediately perform takeover of manual driving, particularly takeover of the operation of the steering wheel, if there is a takeover request for manual driving from the autonomous driving system 1.

The driver state recognition apparatus 20 is configured to include an external interface (external I/F) 21, a control unit 22, and a storage unit 26. The control unit 22 is configured to include a Central Processing Unit (CPU) 23, a Random Access Memory (RAM) 24, and a Read Only Memory (ROM) 25.

The storage unit 26 is configured to include a storage apparatus that stores data with a semiconductor device such as a flash memory, a hard disk drive, a solid-state drive, or other non-volatile memory or volatile memory. The storage unit 26 stores a program 27 to be executed by the driver state recognition apparatus 20 and the like. Note that part or all of the program 27 may be stored in the ROM 25 of the control unit 22.

The camera 31 is an apparatus for capturing a driver who is sitting in a driver's seat. The camera 31 is configured to include a lens unit, an image sensor unit, a light irradiation unit, an input/output unit and a control unit for controlling these units, which are not shown. The image sensor unit is configured to include an image sensor such as a CCD or CMOS sensor, filters, and microlenses. The light irradiation unit includes a light emitting device such as an LED, and may be an infrared LED or the like so as to be able to capture images of the state of the driver both day and night. The control unit is configured to include a CPU, a RAM, and a ROM, for example, and may be configured to include an image processing circuit.

The control unit controls the image sensor unit and the light irradiation unit to irradiate light (e.g. near infrared light etc.) from the light irradiation unit, and performs control for capturing an image of reflected light of the irradiated light using the image sensor unit.

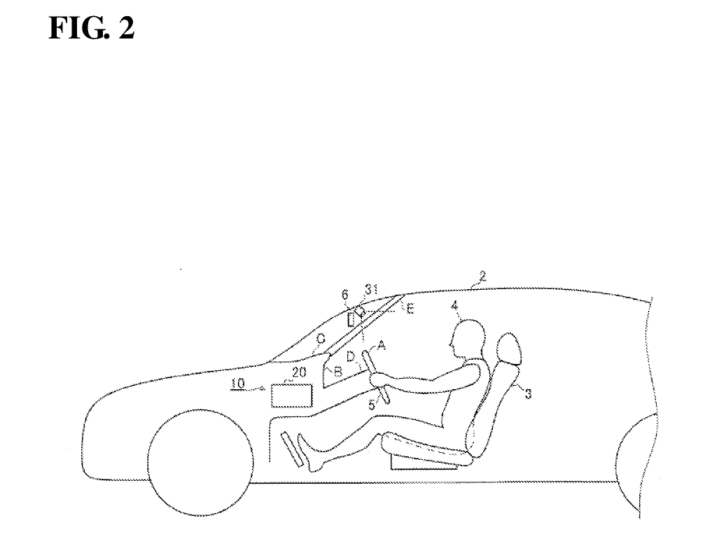

FIG. 2 is a side view showing a vicinity of the driver's seat of a vehicle 2 in which a driver state recognition system 10 according to an embodiment 1 is installed. An attachment position of the camera 31 in the vehicle is not particularly limited, as long as it is a position at which an upper body of a driver 4 who is sitting in a driver's seat 3 can be captured, and it is preferable for the camera 31 to be attached at a position from which a spatial portion from a steering wheel 5 to the driver's seat 3 can be captured. For example, as shown in FIG. 2, it is preferable to attach the camera 31 at a position near a rear-view mirror. Also, as another attachment position, the camera 31 may be installed in the navigation apparatus 40 or the like, in addition to in a steering wheel inner portion A, in a meter panel portion B, on a dashboard C, in a column portion of the steering wheel 5 or on an A pillar portion E.

The number of cameras 31 may be one, or may also be two or more. The camera 31 may be configured separately (i.e. configured as a separate body) from the driver state recognition apparatus 20, or may be integrally configured (i.e.

configured as an integrated body) with the driver state recognition apparatus 20. Also, the type of the camera 31 is not particularly limited, and the camera 31 may be a visible light camera, a near-infrared camera, a far-infrared camera, or a combination of these cameras. In addition, the camera 31 may be a monocular camera, a monocular 3D camera, a stereo camera or the like. The monocular 3D camera includes a distance measurement image chip as an image sensor, and is constituted to be capable of recognizing presence/absence, size, position, posture and the like of an object to be monitored. Image data captured by the camera 31 is sent to the driver state recognition apparatus 20. The driver state recognition system 10 is configured to include the driver state recognition apparatus 20 and the camera 31.

The driver state recognition apparatus 20 and the camera 31 may be connected with a cable, or may be connected wirelessly.

The navigation apparatus 40 shown in FIG. 1 is an apparatus for providing the driver with information such as a current position of the vehicle and a traveling route from the current position to a destination, and is configured to include a control unit, a display unit, an audio output unit, an operation unit, a map data storage unit, and the like (not shown). Also, the navigation apparatus 40 is configured to be capable of acquiring a signal transmitted from a GPS receiver, a gyro sensor, a vehicle speed sensor, and the like (not shown).

The navigation apparatus 40 deduces information such as the road or traffic lane on which the vehicle is traveling and displays the current position on the display unit, based on the vehicle position information measured by the GPS receiver and the map information of the map data storage unit. In addition, the navigation apparatus 40 calculates a route from the current position of the vehicle to the destination and the like, displays the route information and the like on the display unit, and performs audio output of a route guide and the like from the audio output unit.

Also, some types of information such as vehicle position information, information of the road on which the vehicle is traveling, and scheduled traveling route information that are calculated by the navigation apparatus 40 are output to the autonomous driving control apparatus 50. The scheduled traveling route information may also include information related to switching control between autonomous driving and manual driving, such as information on start and end points of autonomous driving zones and information on zones for taking over manual driving from autonomous driving.

The autonomous driving control apparatus 50 is an apparatus for executing various kinds of control related to autonomous driving of the vehicle, and is configured by an electronic control unit including a control unit, a storage unit, an input/output unit and the like (not shown). The autonomous driving control apparatus 50 is also connected to a steering control apparatus, a power source control apparatus, a braking control apparatus, a steering sensor, an accelerator pedal sensor, a brake pedal sensor, and the like (not shown). These control apparatuses and sensors may be included in the configuration of the autonomous driving system 1.

The autonomous driving control apparatus 50 outputs a control signal for performing autonomous driving to each of the control apparatuses, performs autonomous traveling control of the vehicle (autonomous steering control, autonomous speed adjusting control, autonomous braking control and the like), and also performs switching control for switching between the autonomous driving mode and the manual driving mode, based on information acquired from each unit included in the autonomous driving system 1.

“Autonomous driving” refers to allowing the vehicle to autonomously travel along a road under control performed by the autonomous driving control apparatus 50 without the driver in the driver's seat performing the driving operation. For example, a driving state in which the vehicle is allowed to autonomously drive in accordance with a predetermined route to the destination or a traveling route that was automatically created based on circumstances outside of the vehicle and map information is included as autonomous driving. Then, if a predetermined cancelation condition of autonomous driving is satisfied, the autonomous driving control apparatus 50 may end (cancel) autonomous driving. For example, in the case where the autonomous driving control apparatus 50 determines that the vehicle that is driving autonomously has arrived at a predetermined end point of autonomous driving, the autonomous driving control apparatus 50 may perform control for ending autonomous driving. Also, if the driver performs an autonomous driving cancellation operation (for example, operation of an autonomous driving cancellation button, or operation of the steering wheel, acceleration, or braking or the like performed by the driver), the autonomous driving control apparatus 50 may perform control for ending autonomous driving. “Manual driving” refers to driving in which the driver drives the vehicle as the agent that performs the driving operation.

The surroundings monitoring sensor 60 is a sensor that detects target objects that exist around the vehicle. The target objects may include road markings (such as a white line), a safety fence, a highway median, and other structures that affect travelling of the vehicle and the like, in addition to moving objects such as vehicles, bicycles, and people. The surroundings monitoring sensor 60 includes at least one of a forward-monitoring camera, a backward-monitoring camera, a radar, LIDAR (that is, Light Detection and Ranging or Laser Imaging Detection and Ranging) and an ultrasonic sensor. Detection data of the target object detected by the surroundings monitoring sensor 60 is output to the autonomous driving control apparatus 50 and the like. As the forward-monitoring camera and the backward-monitoring camera, a stereo camera, a monocular camera or the like can be employed. The radar transmits radio waves such as millimeter waves to the surroundings of the vehicle, and detects, for example, positions, directions and distances of the target objects by receiving radio waves reflected by the target objects that exist in the surroundings of the vehicle. LIDAR involves transmitting laser light to the surroundings of the vehicle and detecting, for example, positions, directions, and distances of the target objects by receiving light reflected by the target objects that exist in the surroundings of the vehicle.

The audio output unit 61 is an apparatus that outputs various kinds of notifications based on instructions provided from the driver state recognition apparatus 20 with sound and voice, and is configured to include a speaker and the like.

The display unit 62 is an apparatus that displays various kinds of notifications and guidance based on instructions provided from the driver state recognition apparatus 20 with characters and graphics or by lightning and flashing a lamp or the like, and is configured to include various kinds of displays and indication lamps.

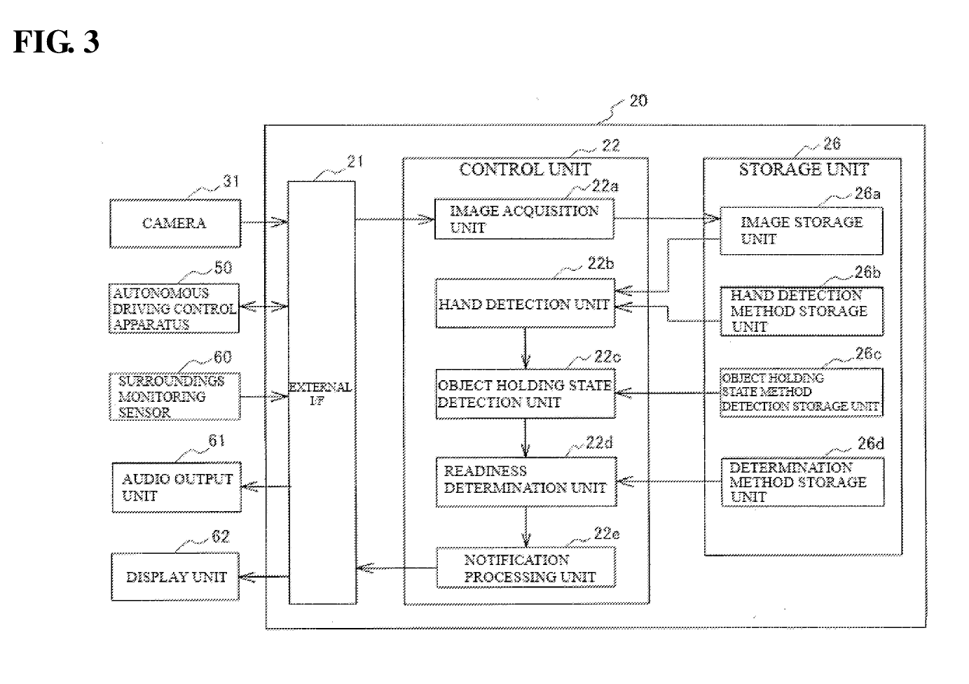

FIG. 3 is a block diagram showing a hardware configuration of the driver state recognition apparatus 20 according to an embodiment 1.

The driver state recognition apparatus 20 is configured to include the external interface (external I/F) 21, the control unit 22, and the storage unit 26. The external I/F 21 is configured to be capable of being connected to, in addition to the camera 31, each unit of the autonomous driving system 1 such as the autonomous driving control apparatus 50, the surroundings monitoring sensor 60, the audio output unit 61, the display unit 62, and is configured by an interface circuit and a connecting connector for transmitting and receiving a signal to and from each of these units.

The control unit 22 is configured to include an image acquisition unit 22a, a hand detection unit 22b, an object holding state detection unit 22c, and a readiness determination unit 22d, and may be configured to further include a notification processing unit 22e. The notification processing unit 22e is an example of a support execution unit. The storage unit 26 is configured to include an image storage unit 26a, a hand detection method storage unit 26b, an object holding state detection method storage unit 26c, and a determination method storage unit 26d.

The image storage unit 26a stores image data of the camera 31 acquired by the image acquisition unit 22a. The hand detection method storage unit 26b stores, for example, a hand detection program to be executed by the hand detection unit 22b of the control unit 22, and data necessary for executing the program.

The object holding state detection method storage unit 26c stores an object holding state detection program, which is executed by the object holding state detection unit 22c of the control unit 22, for detecting a holding state of an object by the hand of the driver, and data necessary for executing the program, and so on.

The determination method storage unit 26d stores a determination program, which is executed by the readiness determination unit 22d of the control unit 22, for determining whether the hands of the driver are in a state of being able to immediately operate the steering wheel, and data necessary for executing the program, and so on.

The control unit 22 is an apparatus that realizes the functions of the image acquisition unit 22a, the hand detection unit 22b, the object holding state detection unit 22c, the readiness determination unit 22d, the notification processing unit 22e and so on, by performing, in cooperation with the storage unit 26, processing for storing various data in the storage unit 26, and by reading out various kinds of data and programs stored in the storage unit 26 and causing the CPU 23 to execute those programs.

The image acquisition unit 22a constituting the control unit 22 performs processing for acquiring the image of the driver that is captured by the camera 31, and performs processing for storing the acquired image data in the image storage unit 26a. The image of the driver may be a still image, or may be a moving image. For example, the image of the driver may be acquired at a predetermined interval (frame rate) after activation of the driver state recognition apparatus 20.

The hand detection unit 22b reads out image data from the image storage unit 26a, performs predetermined image processing for the image data based on the program read out from the hand detection method storage unit 26b, and performs processing for detecting the hand of the driver from the image. As the hand of the driver, the portion from the wrist to the leading end may be included, of may be include also the arm.

As the processing performed in the hand detection unit 22b, various kinds of image processing for detecting coordinates or a region in which the hands of the driver are shown by processing the image captured by the camera 31 can be employed. For example, if a visible light camera is used for the camera 31 and the captured image is a color image, image processing may be performed in which a flesh color region is extracted from color information such as RGB values of each pixel and the hand of the driver is detected from a feature such as the size or shape of the extracted flesh color region.

Also, if a near-infrared camera is used for the camera 31 and the captured image is a near-infrared image, image processing may be performed in which a luminance region corresponding to a flesh color region is extracted from information such as a luminance value of each pixel and the hands of the driver are detected from a feature such as the size or shape of the extracted luminance region.

Also, if a far-infrared camera is used for the camera 31 and the captured image is a far-infrared image, image processing may be performed in which a skin temperature region is extracted based on skin temperature information that can be acquired from the image and the hands of the driver are detected from a feature such as the size or shape of the extracted skin temperature region. Also, if a monocular 3D camera is used for the camera 31, the position of the hands of the driver may be detected using the acquired information such as the detected position or posture of each part of the driver detected by the monocular 3D camera.

The object holding state detection unit 22c performs processing for detecting a holding state of an object by the hands of the driver that are detected by the hand detection unit 22b, and, specifically, performs processing such as detecting whether the driver is in a state of holding an object that is different from an accessory of the vehicle 2 that the driver operates with his or her hands. Accessories of the vehicle 2 that the driver operates with his or her hands include the steering wheel 5 and a gear lever (not shown).

As processing performed by the object holding state detection unit 22c, various kinds of image processing for detecting a holding state of an object by the hands of the driver by processing the image captured by the camera 31 can be employed. For example, by detecting a feature of a region portion that moves with the hands of the driver, that is, a region portion adjacent to the hands of the driver from the image captured by the camera 31, the processing for determining whether the driver is in a state of holding an object may be performed, based on a feature of the region portion that moves with the hand of the driver.

The feature of the region portion that moves with the hand of the driver may be the size or shape of the region portion, color information or luminance information, or may be a combination thereof.

According to this processing, movement of the hand of the driver is detected, and if color information of a region adjacent to the hand of the driver acquired before and after the movement of the hand of the driver is substantially the same, the region in which the color information is substantially the same is determined as the region that shows an object that the driver is holding, and thus it is possible to detect a state in which the driver is holding the object.

Also, it may be detected whether the driver is in a state of holding an object, based on the size or shape of the region in which the color information is substantially the same. According to this configuration, if the size or shape of the region in which the color information is substantially the same is a size or shape that does not hinder holding the steering wheel, in other words, if an object that the driver is holding is small, for example, a small object such as a cigarette or a car key, it may be determined that the driver is not holding an object.

The readiness determination unit 22d performs processing for determining whether the hands of the driver are in a state of being able to immediately operate the steering wheel during autonomous driving, that is, determining whether the readiness for operating the steering wheel of the vehicle is high, based on a holding state of an object that is detected by the object holding state detection unit 22c.

For example, if a predetermined state in which the driver is not holding an object in either hand is detected by the object holding state detection unit 22c, it may be determined that the readiness for operating the steering wheel is high. The predetermined state in which the driver is not holding an object in either hand may be, for example, a state in which a state where the driver is not holding an object in either hand has continued for a predetermined time period, or may be a state in which a state where the driver does not hold the object in either hand has been detected a predetermined number of times within a certain time period.

The readiness for the operation of the steering wheel refers to the rapidity with which the driver can operate the steering wheel 5 if the autonomous driving system 1 stops operating for some reason and autonomous driving cannot be continued. Accordingly, the state of high readiness for the operation of the steering wheel means the state in which the driver can operate the steering wheel as soon as the driver needs to operate the steering wheel, and thus it is not necessary for the driver to be holding the steering wheel.

Also, if a predetermined state in which the driver is holding an object with at least one hand is detected by the object holding state detection unit 22c, it may be determined that the readiness for operating the steering wheel is low. The predetermined state in which the driver is holding an object with at least one hand may be, for example, a state in which a state where the driver is holding an object with at least one hand has continued for a predetermined time period, or may be a state in which a state where the driver is holding the object with at least one hand has been detected a predetermined number of times within a certain time period.

If the readiness determination unit 22e determines that the driver is not in a state of being able to immediately operate the steering wheel, that is, if it is determined that the readiness for operating the steering wheel is low, the notification processing unit 22d performs the notification processing for causing the audio output unit 61 and the display unit 62 to perform audio output and display output for prompting the driver to adopt a state of being able to immediately operate the steering wheel. Also, the notification processing unit 22e may output a signal notifying to continue autonomous driving rather than cancel autonomous driving to the autonomous driving control apparatus 50.

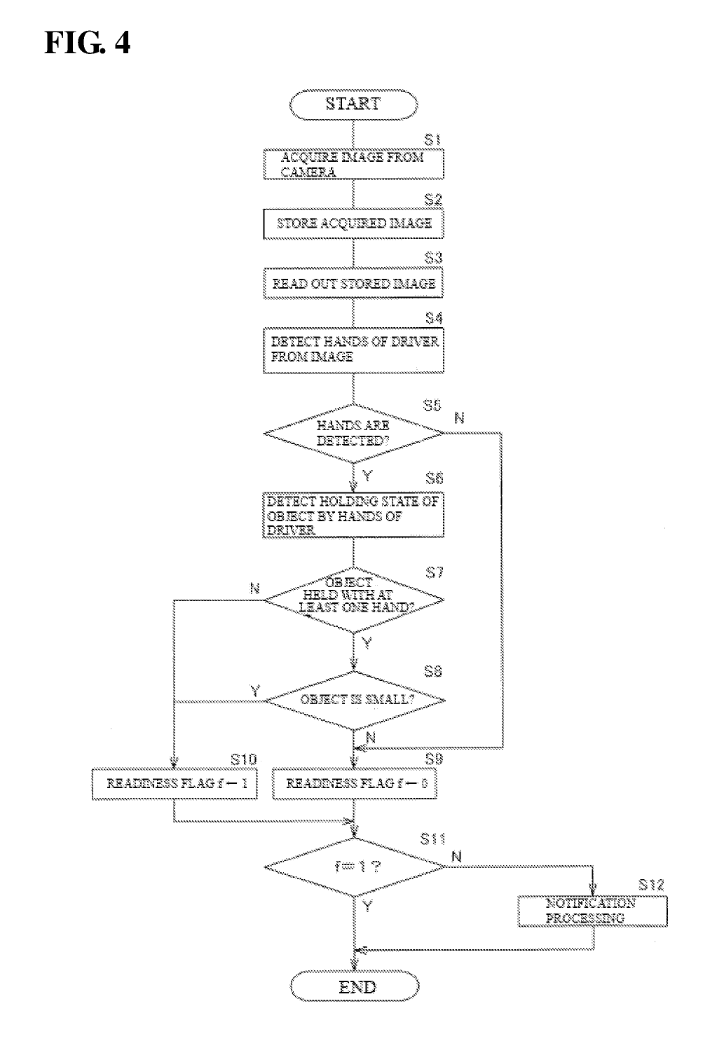

FIG. 4 is a flowchart showing a processing operation performed by the control unit 22 in the driver state recognition apparatus 20 according to an embodiment 1. Here, description will be given, assuming a state in which the autonomous driving system 1 is set to the autonomous driving mode, that is, the vehicle is in a state of traveling under autonomous driving control. This processing operation is repeatedly performed during the period in which the autonomous driving mode is set.

First, in step S1, processing for acquiring image data of the driver captured by the camera 31 is performed. Image data may be acquired from the camera 31 one frame at a time, or multiple frames of image data or frames of image data over a certain time period may be collectively acquired. In the following step S2, processing for storing the acquired image data in the image storage unit 26a is performed, and thereafter the processing moves to step S3.

In step S3, the image data stored in the image storage unit 26a is read out, and then the processing moves to step S4. The image data may be read out from the image storage unit 26a one frame at a time, or the multiple frames of image data or frames of image data over a certain time period may be collectively read out. In step S4, processing for detecting the hands of the driver from the read image data, for example, processing for detecting coordinates or a region of the hands of the driver in the image is performed, and thereafter the processing moves to step S5.

For the processing, which is performed in step S4, for determining the hands of the driver from the image data, various types of image processing according to the characteristics of the camera 31 can be applied.

For example, if a visible light camera is used for the camera 31 and the captured image is a color image, processing may be performed in which a flesh color region is extracted from color information such as RGB values of each pixel, the hand of the driver is detected from a feature such as the size or shape of the extracted flesh color region, and coordinates data or region data of the hands of the driver in the image are output.

Also, if a near-infrared camera is used for the camera 31 and the captured image is a near-infrared image, processing may be performed in which a luminance region corresponding to a flesh color region is extracted from information such as a luminance value of each pixel, the hands of the driver are detected from a feature such as the size or shape of the extracted luminance region, and coordinates data or region data of the hands of the driver in the image are output.

Also, if a far-infrared camera is used for the camera 31 and the captured image is a far-infrared image, processing may be performed in which a skin temperature region is extracted based on skin temperature information that can be obtained from the image, the hand of the driver is detected from a feature such as the size or shape of the extracted skin temperature region, and coordinates data or region data of the hands of the driver in the image are output.

Also, if a monocular 3D camera is used for the camera 31, a position of the hands of the driver in the image may be detected using acquired information such as the detected position or posture of each part of the driver detected by the monocular 3D camera, and the detected data may be output.

In step S5, it is determined whether the hands of the driver have been detected. In step S5, it may be determined whether the hands of the driver have not been detected continuously for a predetermined time period, of it may be determined whether the hands of the driver have not been detected a predetermined number of times within a certain time period. A case in which the hands of the driver have not been detected is a case in which the hands of the driver are not shown in the image such as a state in which the hands of the driver are not in the captured area of the camera 31 or a state in which the hands of the driver are behind some object.

If it is determined in step S5 that the hands of the driver have not been detected, thereafter the processing moves to step S9. On the other hand, if it is determined in step S5 that the hands of the driver have been detected, thereafter the processing moves to step S6. Processing for detecting a holding state of an object by the hands of the driver is performed in step S6, and then the processing moves to step S7. Various types of image processing can be applied to the processing, which is performed in step S6, for detecting a holding state of an object by the hands of the driver. An object described here is an object that is different from accessories of the vehicle 2 (for example, the steering wheel, a gear lever and the like) that the driver operates with his or her hands.

For example, a feature of a region portion that moves with the hands of the driver (a region portion adjacent to the hands) is detected from the image, processing for detecting whether the driver is holding an object may be performed, based on a feature of the region portion that moves with the hand of the driver.

The feature of the region portion that moves with the hand of the driver may be the size or shape of the region portion, color information or luminance information, or may be a combination thereof.

For example, the movement of the driver is detected, if color information or luminance information of a region adjacent to the hand of the driver acquired before and after the movement of the hand of the driver is substantially the same, the region in which the color information or the luminance information is substantially the same is determined as the region that shows an object that the driver is holding, and thus it may be detected that the state is a state in which the driver is holding the object. Also, it may be detected whether the driver is in a state of holding an object, based on the size or shape of the region in which the color information or the luminance information acquired before and after the movement of the hand of the driver is substantially the same.

In step S7, it is determined whether a predetermined state in which the driver is holding an object with at least one hand is detected from the detection processing of step S6, and if it is determined that the predetermined state in which the driver is holding an object with at least one hand is detected, thereafter the processing moves to step S8. The predetermined state in which the driver is holding an object with at least one hand may be a state in which a state where the driver is holding an object with at least one hand has continued for a predetermined time period, or may be a state in which a state where the driver is holding the object with at least one hand has been detected a predetermined number of times within a certain time period.

Note that instead of processing of step S7, processing for determining whether a predetermined state in which the driver is not holding an object in either hand is detected may be employed. In this case, if it is determined that the predetermined state in which the driver is not holding an object in either hand is not detected, the processing may move to step S8, whereas if it is determined that the predetermined state in which the driver is not holding an object in either hand is detected, the processing may move to step S10.

In step S8, it is determined whether the size of an object that the driver is holding is a size that does not hinder holding the steering wheel, that is, it is determined whether an object that the driver is holding is small, and if the object that the driver is holding is not small, that is, if it is determined that the size of the object is a size that hinders holding the steering wheel, thereafter the processing moves to step S9. Note that step S8 is not always necessary, if it is determined that the predetermined state in which the driver is holding an object with at least one hand is detected in step S7, the processing may move to step S9.

In step S9, a readiness flag f for determining whether the hand of the driver is in a state of being able to immediately operate the steering wheel of the vehicle during autonomous driving is set to 0, and thereafter the processing moves to step S11. A state in which the readiness flag is zero shows that the driver is not in a state of being able to immediately operate the steering wheel, that is, that the readiness for operating the steering wheel is in a low state.

On the other hand, in step S7, if it is determined that the predetermined state in which the driver is holding an object with at least one of the hand is not detected, in other words, if it is determined that a state in which the driver is not holding an object in either hand is detected, thereafter the processing moves to step S10.

Also, in step S8, if it is determined that the size of an object that the driver is holding is a size that does not hinder holding the steering wheel, that is, if it is determined that the object that the driver is holding is small, thereafter the processing moves to step S10. The determination of whether the size hinders holding the steering wheel may be defined, for example, based on whether the thumb and the fingers other than the thumb can contact each other when the driver is holding an object. An object whose size does not hinder holding the steering wheel includes a small object, such as a cigarette or the car key, that can be held with two fingers. On the other hand, an object whose size hinders holding the steering wheel includes food whose size is approximately same as the palm, such as a hamburger, a beverage container such as a PET bottle, a portable terminal such as a smartphone, or an object large enough to be difficult to hold without using both hands fully, such as a magazine or a book.

In step S10, the readiness flag f for determining whether the hands of the driver are in a state of being able to immediately operate the steering wheel of the vehicle during autonomous driving is set to 1, and thereafter the processing moves to step S11. A state in which the readiness flag is 1 shows that the driver is in a state of being able to immediately operate the steering wheel, that is, that the readiness for operating the steering wheel is in a high state.

It is determined whether the readiness flag is 1 in step S11, and if it is determined that the readiness flag is 1, that is, if it is determined that the readiness for operating the steering wheel is in the high state, thereafter the processing ends. Note that, in another embodiment, notification processing for notifying the driver that the readiness of the hands is in the high state may be performed, such as, for example, by providing an appropriate posture notification lamp in the display unit 62 and turning on an appropriate posture notification lamp. Alternatively, a signal notifying the driver that the driver is in a state of being able to immediately operate the steering wheel, that is, that the driver is adopting an appropriate posture for continuing autonomous driving, may be output to the autonomous driving control apparatus 50.

On the other hand, if the readiness flag is not 1 but is 0, that is, if it is determined that the readiness for operating the steering wheel is in the low state, the processing moves to step S12. In step S12, notification processing is performed to the driver.

As the notification processing, processing for outputting predetermined audio from the audio output unit 61 may be performed, or processing for displaying predetermined display on the display unit 62 may be performed. The notification processing is processing for alerting attention to the driver such that the driver adopts a state of the hands that enables the driver to immediately operate the steering wheel in the case where a failure or the like occurs in the autonomous driving system 1. For example, audio such as “please put down what you have in your hand” may be output, or display for prompting the driver not to hold anything in his or her hands may be performed. Also, in step S12, a signal notifying to continue autonomous driving rather than cancel autonomous driving may be output to the autonomous driving control apparatus 50.

In the above driver state recognition apparatus 20 according to an embodiment 1, the hand detection unit 22b detects the hands of the driver from an image captured by the camera 31, the object holding state detection unit 22c detects a holding state of an object by the hands of the driver, and the readiness determination unit 22d determines whether the hands of the driver are in a state of being able to immediately operate the steering wheel of the vehicle during autonomous driving, based on the holding state of the object. In this manner, it is possible to accurately recognize whether the state of the hands is a state of being able to immediately take over the operation of the steering wheel during autonomous driving, and it is possible to appropriately provide support such that takeover of manual driving from autonomous driving, particularly takeover of the operation of the steering wheel, can be performed promptly and smoothly even in cases such as where a failure occurs in the autonomous driving system 1 during autonomous driving.

Also, according to the driver state recognition apparatus 20, because a feature of a region portion that moves with the hands of the driver in the image is analyzed by the object holding state detection unit 22c, it is possible to accurately detect whether the driver is in a state of holding an object that is different from an accessory of the vehicle that the driver operates with his or her hands. Also, if the size or shape of the region portion that moves with the hand of the driver is a size or shape that does not hinder holding the steering wheel, it is also possible to detect the state as a state in which the driver is not holding an object, and it is possible to perform detection conforming to the actual operation of the steering wheel, such as whether the driver is in a state of holding an object that hinders holding the steering wheel.

Also, in the driver state recognition apparatus 20, if the readiness determination unit detects a predetermined state in which the driver is holding an object with at least one hand, it is determined that the readiness is in the low state. In this manner, it is possible to accurately determine that the driver is not in a state of being able to immediately operate the steering wheel with both hands.

Also, according to the driver state recognition apparatus 20, if the readiness determination unit detects a predetermined state in which the driver is not holding an object in either hand, it is determined that the readiness is in the high state. In this manner, it is possible to accurately determine that the driver is in a state of being able to immediately operate the steering wheel with both hands.

Also, according to the driver state recognition apparatus 20, if the readiness determination unit 22d determines that the driver is not in a state of being able to immediately operate the steering wheel of the vehicle, the notification processing unit 22e performs processing for transmitting a notification to the driver. In this manner, it is possible to prompt the driver to correct the state of his or her hands so as to keep a state of the hands that enables the driver to immediately operate the steering wheel even during autonomous driving.

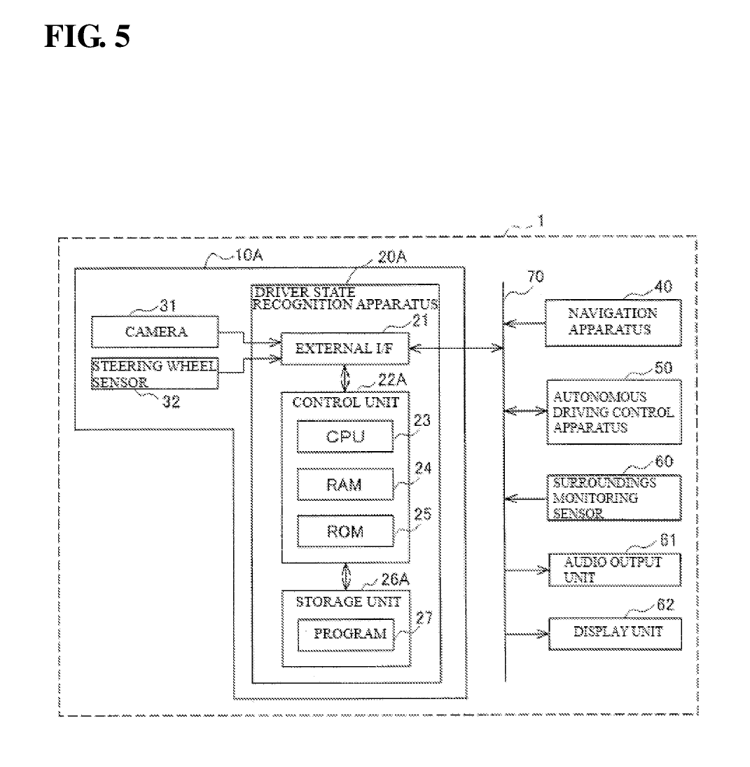

FIG. 5 is a block diagram showing a configuration of a relevant section of an autonomous driving system 1 that includes a driver state recognition apparatus 20A according to an embodiment 2. Note that constituent components that have the same functions as those of the autonomous driving system 1 shown in FIG. 1 are assigned the same numerals, and description thereof is omitted here.

Embodiments 1 and 2 differ greatly in that the camera 31 is used in the driver state recognition system 10 according to an embodiment 1, whereas a steering wheel sensor 32 is provided in addition to the camera 31 in a driver state recognition system 10A according to an embodiment 2.

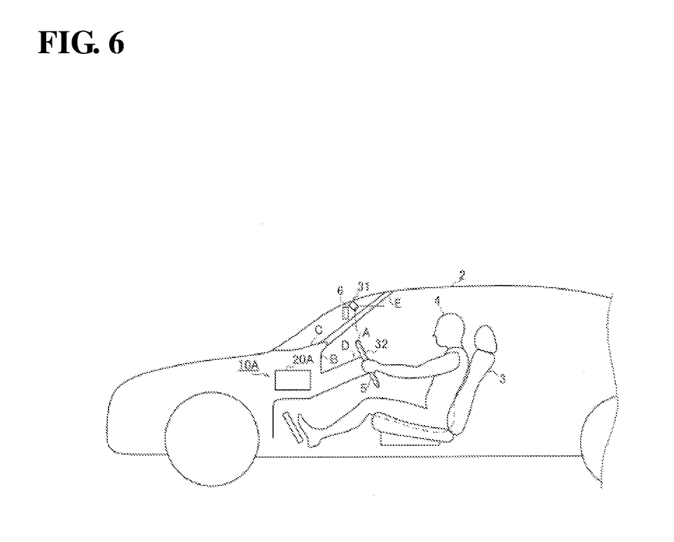

FIG. 6 is a side view showing a vicinity of a driver's seat of the vehicle 2 in which the driver state recognition system 10A according to an embodiment 2 is installed.

The steering wheel sensor 32 is provided in the steering wheel 5 of the vehicle 2, and is not particularly limited as long as the sensor is able to detect a hand that touches the steering wheel 5. The steering wheel sensor 32 may be, for example, an electrostatic capacitance sensor or a pressure sensitive sensor, or may be a biosensor that detects biological information such as a heartbeat or a pulse from a hand that touches the steering wheel 5.

The electrostatic capacitance sensor is a sensor that detects contact with the steering wheel 5 by the hand, by detecting a change of electrostatic capacity that occurs between an electrode unit provided in the steering wheel 5 and the hand. The pressure sensitive sensor is a sensor that detects contact with the steering wheel 5 by the hand, by detecting pressure generated at the time when the driver holds the steering wheel 5, from a change of contact area (resistance value) between the electrode unit and a detection unit provided in the steering wheel 5. Multiple steering wheel sensors 32 may be provided in a circumference portion or a spoke portion of the steering wheel 5 so as to detect a contact position of the hand on the steering wheel 5. A signal detected by the steering wheel sensor 32 is output to the driver state recognition apparatus 20A.

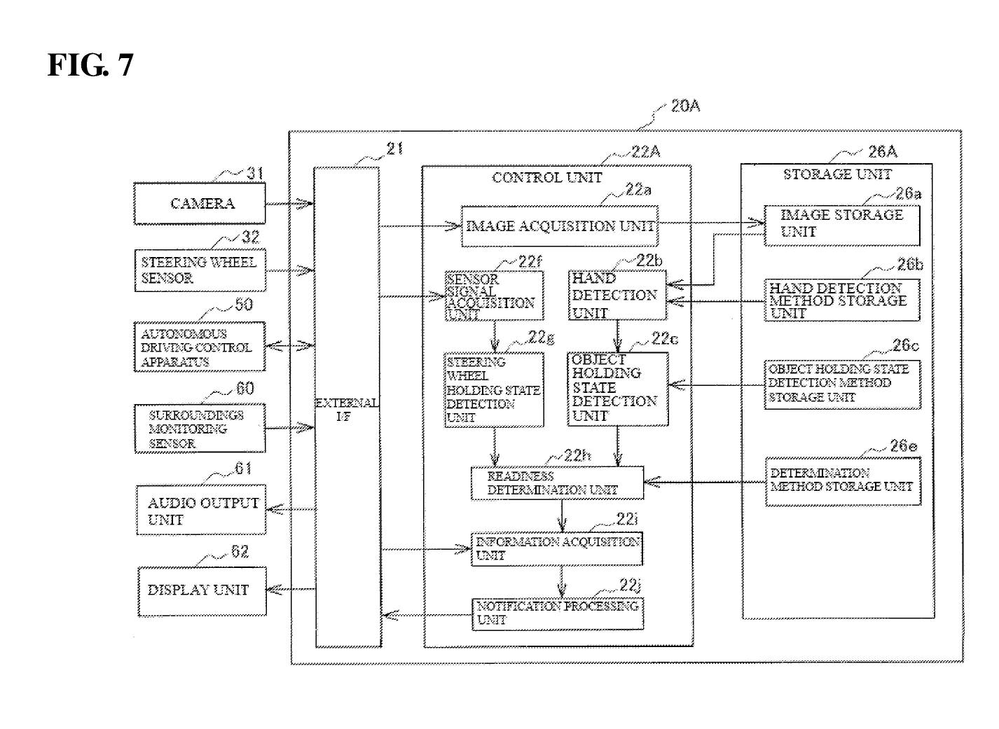

FIG. 7 is a block diagram showing an example of a hardware configuration of the driver state recognition apparatus 20A according to an embodiment 2. Note that constituent components that have the same functions as those of the driver state recognition apparatus 20 shown in FIG. 3 are assigned the same numerals, and description thereof is omitted here.

The driver state recognition apparatus 20A according to an embodiment 2 differs from the driver state recognition apparatus 20 according to an embodiment 1 in that a control unit 22A further includes a sensor signal acquisition unit 22f, a steering wheel holding state detection unit 22g, and an information acquisition unit 22i, and in that the processing performed by a readiness determination unit 22h and a notification processing unit 22j differs following the addition of these units.

The control unit 22A is configured to include the image acquisition unit 22a, the hand detection unit 22b, the object holding state detection unit 22c, the sensor signal acquisition unit 22f, the steering wheel holding state detection unit 22g, the readiness determination unit 22h, the information acquisition unit 22i, and the notification processing unit 22j. The notification processing unit 22j is an example of a support execution unit. A storage unit 26A is configured to include the image storage unit 26a, the hand detection method storage unit 26b, the object holding state detection method storage unit 26c, and a determination method storage unit 26e.

The image storage unit 26a stores image data of the camera 31 acquired by the image acquisition unit 22a. The hand detection method storage unit 26b stores a hand detection program to be executed by the hand detection unit 22b of the control unit 22, data necessary for executing the program, and the like. The object holding state detection method storage unit 26c stores an object holding state detection program to be executed by the object holding state detection unit 22c of the control unit 22A, data necessary for executing the program, and the like.

The determination method storage unit 26e stores a determination program, which is executed by the readiness determination unit 22h of the control unit 22A, for detecting whether the hands of the driver are in a state of being able to immediately operate the steering wheel, data that is necessary for executing the program, and the like.

The image acquisition unit 22a constituting the control unit 22A performs processing for acquiring the image of the driver that is captured by the camera 31, and performs processing for storing the acquired image data in the image storage unit 26a.

The hand detection unit 22b reads out image data from the image storage unit 26a, performs predetermined image processing for the image data based on the program read out from the hand detection method storage unit 26b, and performs processing for detecting the hands of the driver in the image.

The object holding state detection unit 22c performs processing for detecting a holding state of an object by the hands of the driver that is detected by the hand detection unit 22b, for example, performs for detecting whether the driver is in a state of holding an object.

The sensor signal acquisition unit 22f performs processing for acquiring a sensor signal detected by the steering wheel sensor 32. The steering wheel holding state detection unit 22g performs processing for detecting a holding state of the steering wheel by the driver, based on the sensor signal acquired by the sensor signal acquisition unit 22f. Note that as a holding state of the steering wheel, not only a state in which the steering wheel is being held by the hands, but also a state in which the hands are contacting the steering wheel (a state in which the hands are placed on the steering wheel) may be included.

The readiness determination unit 22h performs processing for determining whether the hands of the driver are in a state of being able to immediately operate the steering wheel during autonomous driving, based on a holding state of an object detected by the object holding state detection unit 22c and a holding state of the steering wheel detected by the steering wheel holding state detection unit 22g.

For example, if a state in which the steering wheel is not held is detected by the steering wheel holding state detection unit 22g, and a state in which the driver is not holding an object in either hand is detected by the object holding state detection unit 22c, it may be determined that the driver is in a state of being able to immediately operate the steering wheel during autonomous driving.

Also, if a state in which the steering wheel is not held is detected by the steering wheel holding state detection unit 22g, and a state in which the driver is holding an object with at least one hand is detected by the object holding state detection unit 22c, it may be determined that the driver is not in a state of being able to immediately operate the steering wheel during autonomous driving.

Also, if a state in which the steering wheel is held with both hands is detected by the steering wheel holding state detection unit 22g, it may be determined that the driver is in a state of being able to immediately operate the steering wheel during autonomous driving, regardless of a detection state by the object holding state detection unit 22c.

The information acquisition unit 22i acquires information arising during the autonomous driving from the units of the autonomous driving system 1. The information arising during the autonomous driving includes at least one of monitoring information of surroundings of the vehicle that is detected by the surroundings monitoring sensor 60 and takeover request information for taking over manual driving from autonomous driving that is sent from the autonomous driving control apparatus 50.

If the readiness determination unit 22g determines that the driver is not in a state of being able to immediately operate the steering wheel, the notification processing unit 22j performs processing for causing the audio output unit 61 and the display unit 62 to perform output processing for audio and display for prompting the driver to adopt a state of the hands that enables the driver to immediately operate the steering wheel, according to the information arising during autonomous driving that is acquired by the information acquisition unit 22i. Also, the notification processing unit 22j may output a signal notifying the autonomous driving control apparatus 50 to continue autonomous driving rather than cancel autonomous driving.

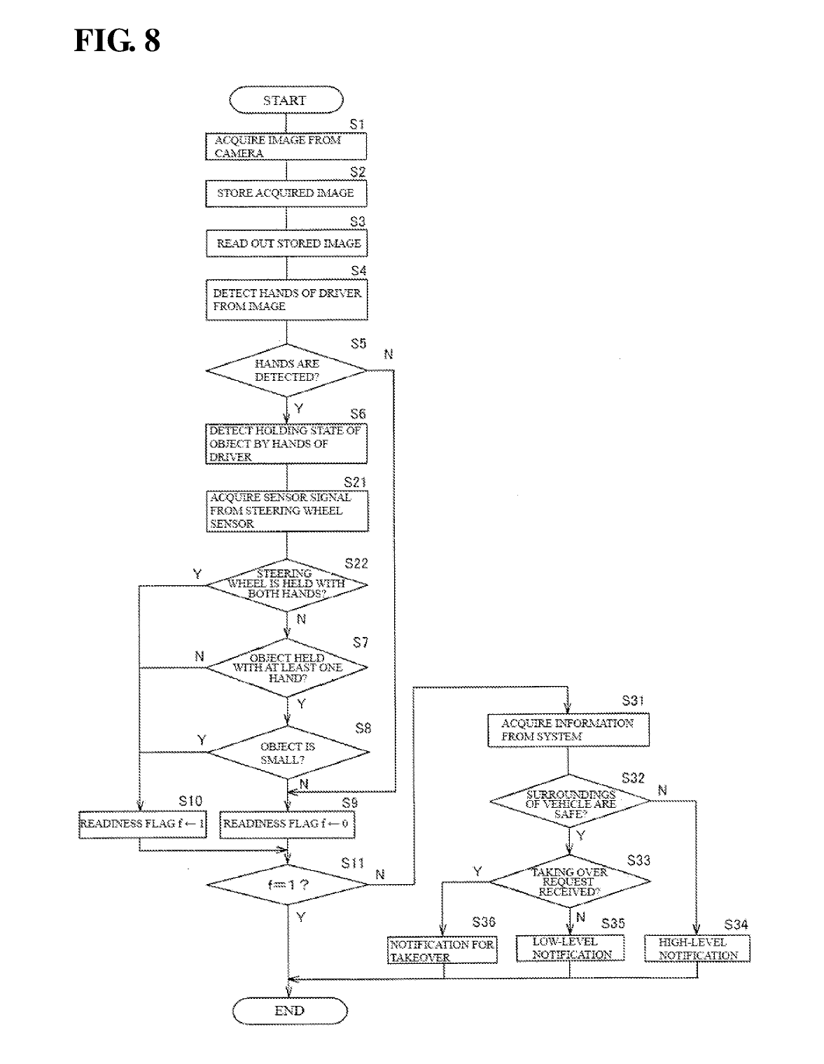

FIG. 8 is a flowchart showing a processing operation performed by the control unit 22A in the driver state recognition apparatus 20A according to an embodiment 2. The processing operation of the flowchart shown in FIG. 8 differs from that of the flowchart shown in FIG. 4 in that steps S21 and 22 are inserted between steps S6 and S7, and in that steps S31 to S36 are inserted instead of step S12. Processing operations that have the same contents as that of the flowchart shown in FIG. 4 are assigned the same numerals, and description thereof is omitted.

First, in step S1, processing for acquiring image data of the driver captured by the camera 31 is performed, and then, in step S2, processing for storing the acquired image in the image storage unit 26a is performed. The image is read out from the image storage unit 26a in step S3, and in the following step S4, processing for detecting the hand of the driver from the read image data is performed, and thereafter the processing moves to step S5.

In step S5, it is determined whether the hands of the driver are detected. If it is determined that the hands of the driver are not detected in step S5, the processing moves to step S9, whereas if it is determined that the hands of the driver are detected in step S5, the processing moves to step S6. Processing for detecting a holding state of an object by the hands of the driver is performed in step S6, and then the processing moves to step S21.

Processing for acquiring a sensor signal from the steering wheel sensor 32 is performed in step S21, and, in the following step S22, it is determined whether the driver is holding the steering wheel with both hands based on the acquired sensor signal. If the sensor signal is a signal that shows there are two contact points, it is determined that the steering wheel is held with both hands.

If it is determined that the steering wheel is not held with both hands in step S22, that is, if it is determined that the steering wheel is held with one hand or is not held with either hand, thereafter the processing moves to step S7.

In step S7, it is determined whether a predetermined state in which the driver is holding an object with at least one hand is detected from a result of the detection processing of step S6, and if it is determined that the predetermined state in which the driver is holding an object with at least one hand is detected, thereafter the processing moves to step S8.

In step S8, it is determined whether the size of an object that the driver is holding is a size that does not hinder holding the steering wheel, that is, it is determined whether an object that the driver is holding is small, and if the object that the driver is holding is not small, that is, if it is determined that the size of the object is a size that hinders holding the steering wheel, thereafter the processing moves to step S9. Note that step S8 is not always necessary, if it is determined that the predetermined state in which the driver is holding an object with at least one hand is detected in step S7, the processing may move to step S9.

In step S9, the readiness flag f is set to 0, and thereafter the processing moves to step S11. A state in which the readiness flag is 0 shows that the driver is not in a state of being able to immediately operate the steering wheel, that is, that the readiness for operating the steering wheel is in a low state.

On the other hand, if it is determined that the steering wheel is held with both hands in step S22, the processing moves to step S10.

Also, in step S7, if it is determined that the predetermined state in which the driver is holding an object with at least one of the hand is not detected, in other words, if it is determined that a state in which the driver is not holding an object in either hand is detected, thereafter the processing moves to step S10.

Furthermore, in step S8, if it is determined that the size of an object that the driver is holding is a size that does not hinder holding the steering wheel, that is, if it is determined that the object that the driver is holding is small, thereafter the processing moves to step S10.

In step S10, the readiness flag f is set to 1, and thereafter the processing moves to step S11. A state in which the readiness flag is 1 shows that the driver is in a state of being able to immediately operate the steering wheel, that is, that the readiness for operating the steering wheel is in a high state.

It is determined whether the readiness flag is 1 in step S11, and if it is determined that the readiness flag is 1, that is, if it is determined that the readiness for operating the steering wheel is in the high state, thereafter the processing ends. On the other hand, if the readiness flag is not 1 but is 0, that is, if it is determined that the readiness for operating the steering wheel is in the low state, the processing moves to step S31.

Information is acquired from the autonomous driving system 3 in step S31, and then the processing moves to step S32. The information includes the monitoring information of surroundings of the vehicle that is detected by the surroundings monitoring sensor 60 and the takeover request information for taking over manual driving that is output from the autonomous driving control apparatus 50. The takeover request information includes, for example, a system abnormality (failure) occurrence signal, a system functional limit signal, or an entry signal indicating entry to a takeover zone.

In step S32, it is determined whether the surroundings of the vehicle are in a safe state, based on the monitoring information of surroundings of the vehicle that is acquired from the surroundings monitoring sensor 60. In step S32, if it is determined that the surroundings of the vehicle are not in a safe state, such as, for example, if it is determined that information indicating that another vehicle, a person, or other obstacle is detected in a certain range of the surroundings of the vehicle (any of forward, lateral, and backward), information notifying that another vehicle is rapidly approaching, or information indicating that the vehicle will travel on a road where the functional limit of the system is envisioned, such as a narrow road with sharp curbs was acquired, the processing moves to a high-level notification processing of step S34. In step 34, the high-level notification processing for causing the driver to swiftly adopt a state of the hands that enables the driver to immediately operate the steering wheel is performed, and thereafter the processing ends. In the high-level notification processing, it is preferable that notification is performed in which display and audio are combined. Notification other than display or audio, such as, for example, applying vibrations to the driver's seat or the like may be added. Also, in step S34, a signal notifying to continue autonomous driving rather than cancel autonomous driving may be output to the autonomous driving control apparatus 50.

On the other hand, in step S32, if it is determined that the surroundings of the vehicle are in a safe state, thereafter the processing moves to step S33. In step S33, it is determined whether the takeover request information for taking over manual driving is acquired from the autonomous driving control apparatus 50, that is, it is determined whether there is a takeover request.

In step S33, if it is determined that there is no takeover request, the processing moves to the low-level notification processing of step S35. In step S35, the low-level notification processing is performed for causing the driver to adopt a state of the hands that enables the driver to hold the steering wheel, and then the processing ends. In the low-level notification processing, it is preferable to gently notify the driver, such as notification through display only, in order to achieve harmony between the autonomous driving and the driver.

On the other hand, in step S33, if it is determined that there is the takeover request, the processing moves to step S36. In step S36, takeover notification is performed by audio or display such that the driver immediately holds the steering wheel and takes over the driving, and then the processing ends.

With the above driver state recognition apparatus 20A according to an embodiment 2, it is determined whether the driver is in a state of being able to immediately operate the steering wheel during autonomous driving, based on a holding state of an object detected by the object holding state detection unit 22c and a holding state of the steering wheel detected by the steering wheel holding state detection unit 22g. In this manner, it is possible to prevent erroneously detecting that the state of holding the steering wheel is a state of holding an object other than the steering wheel, and thus it is possible to accurately detect whether the driver is holding an object other than the steering wheel. As a result, it is possible to improve determination accuracy for determining whether the hand of the driver is in a state of being able to immediately operate the steering wheel during autonomous driving.

Also, according to the driver state recognition apparatus 20A, the notification processing unit 22j performs notification processing to the driver according to the information arising during autonomous driving that is acquired by the information acquisition unit 22i. If surroundings monitoring information indicating that the vehicle surroundings are not in a safe state is acquired, it is possible to raise the level of the notification performed by the notification processing unit 22j to more strongly alert the driver, such that the driver adopts a posture that enables the driver to immediately take over the steering wheel operation. Also, if the surroundings of the vehicle are safe, and there is no takeover request, it is possible to gently prompt the driver to correct the state of his or her hands through the low-level notification. On the other hand, if there is the takeover request information, it is possible to notify the driver to adopt a posture for immediately taking over manual driving.

In this manner, it is not required to needlessly perform various notifications to the driver according to the state of the autonomous driving system 1, and thus power and processing required for the notification can be reduced. Also, at the time of failure occurrence or an operating limit of the system, or at the time of a request for taking over the manual driving, the time period until the driver operates the steering wheel and the takeover of the driving operation is completed can be shortened, thus enabling a prompt and smooth takeover to be performed. It is also possible to perform an appropriate notification that is gentle on the driver, according to the state of the autonomous driving system 1.

Note that, the information acquisition unit 22i may be provided in the driver state recognition apparatus 20 according to an embodiment 1, and instead of step S12 shown in FIG. 4, similar processing of steps S31 to s36 shown in FIG. 8, that is, support for the driver such as various kinds of notification processing and the like, may be performed to the driver, according to information arising during autonomous driving that is acquired by the information acquisition unit 22i.

Also, the above driver state recognition apparatus 20A according to an embodiment 2 is configured such that the sensor signal is acquired from the steering wheel sensor 32 and a holding state of the steering wheel is detected based on the acquired sensor signal, but in another embodiment, it may be detected whether the driver is holding the steering wheel from the image captured by the camera 31 without providing the steering wheel sensor 32.

For example, if the steering wheel is captured in an image captured by the camera 31, the hand placed on the steering wheel may be detected based on skin color information or luminance information. Also, if the steering wheel is not captured in an image captured by the camera 31, a state in which the driver is holding the steering wheel may be detected from information on an image that shows whether the arms of the driver are extended in the direction of the steering wheel, and the like.

1. A driver state recognition apparatus for recognizing a state of a driver of a vehicle provided with an autonomous driving system, comprising:
an image acquisition unit configured to acquire an image captured by a camera configured to capture the driver;
a hand detection unit configured to detect a hand of the driver from the image acquired by the image acquisition unit;
an object holding state detection unit configured to detect a holding state of an object by the hand of the driver that is detected by the hand detection unit; and
a readiness determination unit configured to determine whether the hand of the driver is in a state of being able to immediately operate a steering wheel of the vehicle during autonomous driving, based on the holding state of the object that is detected by the object holding state detection unit,
wherein the object is an object that is different from an accessory of the vehicle that the driver operates with the hand.

2. The driver state recognition apparatus according to claim 1,
wherein the object holding state detection unit detects a feature of a region portion that moves with the hand of the driver from the image, and determines whether the driver is in a state of holding the object, based on the feature of the region portion that moves with the hand of the driver and is detected from the image.

3. The driver state recognition apparatus according to claim 1,
wherein, if the object holding state detection unit detects a predetermined state in which the driver is not holding the object in either hand, the readiness determination unit determines that the driver is in the state of being able to immediately operate the steering wheel during autonomous driving.

4. The driver state recognition apparatus according to claim 1,
wherein, if the object holding state detection unit detects a predetermined state in which the driver is holding the object with at least one hand, the readiness determination unit determines that the driver is not in the state of being able to immediately operate the steering wheel during autonomous driving.

5. The driver state recognition apparatus according to claim 1,
wherein, if the object holding state detection unit detects the holding state of the object, the readiness determination unit determines whether the hand of the driver is in the state of being able to immediately operate the steering wheel of the vehicle during autonomous driving, based on a size of the object.

6. The driver state recognition apparatus according to claim 1, further comprising:
a steering wheel holding state detection unit configured to detect a holding state of the steering wheel by the driver,
wherein the readiness determination unit determines whether the driver is in the state of being able to immediately operate the steering wheel during autonomous driving, based on the holding state of the object that is detected by the object holding state detection unit and the holding state of the steering wheel that is detected by the steering wheel holding state detection unit.

7. The driver state recognition apparatus according to claim 6, further comprising:
a sensor signal acquisition unit configured to acquire a sensor signal that is based on contact of the hand of the driver from a sensor provided in the steering wheel,
wherein the steering wheel holding state detection unit detects the holding state of the steering wheel by the driver, based on the sensor signal that is acquired by the sensor signal acquisition unit.

8. The driver state recognition apparatus according to claim 6,
wherein the steering wheel holding state detection unit detects the holding state of the steering wheel by the driver from the image.

9. The driver state recognition apparatus according to claim 1, further comprising:
a support execution unit configured to execute support for the driver, if the readiness determination unit determines that the hand of the driver is not in the state of being able to immediately operate the steering wheel.

10. The driver state recognition apparatus according to claim 9, further comprising:
an information acquisition unit configured to acquire information arising during autonomous driving from the autonomous driving system,
wherein the support execution unit executes notification processing to the driver, based on a determination result from the readiness determination unit and the information arising during autonomous driving that is acquired by the information acquisition unit.

11. The driver state recognition apparatus according to claim 10,
wherein the information arising during autonomous driving includes information for determining whether surroundings of the vehicle are in a safe state, and
if it is determined by the readiness determination unit that the hand of the driver is not in the state of being able to immediately operate the steering wheel, the support execution unit executes notification processing after changing a notification level for prompting the driver to correct a state of the hand, according to whether the surroundings of the vehicle are in a safe state.

12. The driver state recognition apparatus according to claim 10,
wherein the information arising during autonomous driving includes takeover request information for taking over manual driving from autonomous driving, and
if it is determined by the readiness determination unit that the hand of the driver is not in the state of being able to immediately operate the steering wheel, and the information acquisition unit acquires the takeover request information, the support execution unit executes notification processing for prompting the driver to take over the operation of the steering wheel.

13. A driver state recognition system comprising:
the driver state recognition apparatus according to claim 1; and
a camera configured to capture the driver.

14. The driver state recognition apparatus according to claim 2,
wherein, if the object holding state detection unit detects a predetermined state in which the driver is not holding the object in either hand, the readiness determination unit determines that the driver is in the state of being able to immediately operate the steering wheel during autonomous driving.

15. The driver state recognition apparatus according to claim 2,
wherein, if the object holding state detection unit detects a predetermined state in which the driver is holding the object with at least one hand, the readiness determination unit determines that the driver is not in the state of being able to immediately operate the steering wheel during autonomous driving.

16. The driver state recognition apparatus according to claim 2,
wherein, if the object holding state detection unit detects the holding state of the object, the readiness determination unit determines whether the hand of the driver is in the state of being able to immediately operate the steering wheel of the vehicle during autonomous driving, based on a size of the object.

17. The driver state recognition apparatus according to claim 2, further comprising:
a steering wheel holding state detection unit configured to detect a holding state of the steering wheel by the driver,
wherein the readiness determination unit determines whether the driver is in the state of being able to immediately operate the steering wheel during autonomous driving, based on the holding state of the object that is detected by the object holding state detection unit and the holding state of the steering wheel that is detected by the steering wheel holding state detection unit.

18. A driver state recognition method for recognizing a state of a driver of a vehicle provided with an autonomous driving system, comprising:
acquiring an image captured by a camera configured to capture the driver;
storing the acquired image in an image storage unit;
reading out the image from the image storage unit;
detecting a hand of the driver from the read image;
detecting a holding state of an object by the detected hand of the driver; and
determining whether the hand of the driver is in a state of being able to immediately operate the steering wheel of the vehicle during autonomous driving, based on the detected holding state of the object,
wherein the object is an object that is different from an accessory of the vehicle that the driver operates with the hand.
